(19) United States
(12) Patent Application Publication
(10) Pub. No.: US 2012/0124136 A1
(43) Pub. Date: May 17, 2012

(54) CONTEXT INFORMATION SHARING APPARATUS AND METHOD FOR PROVIDING INTELLIGENT SERVICE BY SHARING CONTEXT INFORMATION BETWEEN ONE OR MORE TERMINALS

(75) Inventors: Hyun Ki KIM, Daejeon (KR); Soo Jong LIM, Daejeon (KR); Mi Ran CHOI, Daejeon (KR); Pum Mo RYU, Daejeon (KR); Jeong HEO, Daejeon (KR); Chung Hee LEE, Daejeon (KR); Hyo Jung OH, Daejeon (KR); Chang Ki LEE, Daejeon (KR); Yeo Chan YOON, Seoul (KR); Yoon Jae CHOI, Gangwon-do (KR); Ji Ae SHIN, Daejeon (KR); Myung Gil JANG, Daejeon (KR); Sang Kyu PARK, Daejeon (KR)

(73) Assignee: Electronics and Telecommunications Research Institute, Daejon (KR)

(21) Appl. No.: 13/289,361

(22) Filed: Nov. 4, 2011

(30) Foreign Application Priority Data
Nov. 16, 2010 (KR) 10-2010-0113955

(51) Int. Cl. G06F 15/16

(52) U.S. Cl. 709/204

(57) ABSTRACT

Provided are a context information sharing apparatus and method for providing an intelligent service by sharing context information between one or more terminals. The method includes collecting, at one or more terminals, user behavior-based preference information including user log information about each terminal and sensor-based context information, storing, at the one or more terminals, the collected preference information and context information in each terminal as a database, receiving, at a first terminal, a context information collection request for a target user group and identifying the target user group, collecting, at the first terminal, context information about at least one terminal included in the identified target user group, and providing, at the first terminal, preference information about the target user group extracted on the basis of the collected context information about the target user group to a user.

### CLAIM FOR PRIORITY

This application claims priority to Korean Patent Application No. 10-2010-0113955 filed on Nov. 16, 2010 in the Korean Intellectual Property Office (KIPO), the entire contents of which are hereby incorporated by reference.

### BACKGROUND

1. Technical Field

Example embodiments of the present invention relate in general to a context information sharing apparatus and method for providing an intelligent service by sharing context information between one or more terminals, and more particularly, to a context information sharing apparatus and method for collecting and analyzing context information about a plurality of concerned target user groups and presenting and recommending context information about a group user so that a user can immediately make an appropriate decision for context of a target user group.

2. Related Art

A ubiquitous environment denotes an environment in which a user can freely access a network and receive various kinds of service without recognizing a computer or network regardless of a location. In other words, a ubiquitous environment refers to an environment in which information can be economically and conveniently exchanged by any devices any time, anywhere, regardless of media types.

Meanwhile, a sensor information sharing system provides service in which anyone can participate on a web on the basis of a map to easily register his/her sensor and search for real-time sensor information distributed and shared all over the world as well as his/her sensor information.

Conventional techniques proposed in relation to context information-related technology based on a ubiquitous environment include a technique for inferring a service using information, such as various pieces of home context information and a user profile, to provide a context-adaptive custom service to a user in a home network service based on a ubiquitous environment, a context-aware access control management technique for providing a context-based dynamic access control session management service and an active access control service according to duty flow, and so on.

In addition, a technique for collecting context information about surroundings of a user from a plurality of sensor modules to monitor the surroundings of the user in real time, combining the surrounding context information collected from an event signal output when an event occurs to estimate the surrounding context of the user, generating context-aware data according to the estimated surrounding context, and outputting the context-aware data to the outside, a technique for an information processing technology platform and interface covering context information and wide range information, a location-awareness technique for obtaining context and location information about a device using a hierarchical tree structure, etc. have been proposed.

Most of the above-mentioned conventional techniques are centralized methods based on a client-server scheme, managing context information and access authority of a user. However, such a method for centralized management of context information about a user may be misused for commercial purposes. Also, context information related to individual privacy is stored in a server, and thus cannot be directly managed by users.

### SUMMARY

Accordingly, example embodiments of the present invention are provided to substantially obviate one or more problems due to limitations and disadvantages of the related art.

Example embodiments of the present invention provide a context information sharing apparatus and method for collecting and analyzing context information about a plurality of concerned target user groups and presenting and recommending context information about a group user so that a user can immediately make an appropriate decision for context of a target user group.

In some example embodiments, a context information sharing method for providing an intelligent service by sharing context information between one or more terminals includes: collecting, the one or more terminals, user behavior-based preference information including user log information about each terminal and sensor-based context information; storing, at the one or more terminal, the collected preference information and context information in each terminal as a database; receiving, at a first terminal, a context information collection request for a target user group and identifying the target user group; collecting, at the first terminal, context information about at least one terminal included in the identified target user group; and providing, at the first terminal, preference information about the target user group extracted on the basis of the collected context information about the target user group to a user.

The one or more terminals may be ubiquitous terminals.

Collecting, at the first terminal, the context information about the at least one terminal included in the identified target user group may include: searching for a route to the target user group; visiting the at least one terminal included in the target user group to check whether the first terminal has a collection user authority; and obtaining preference information about each terminal when the first terminal has the collection user authority.

Providing, at the first terminal, the preference information about the target user group extracted on the basis of the collected context information about the target user group to the user may include: gathering preference information about the at least one terminal included in the target user group to compute the preference information about the target user group; providing the preference information about the target user group to the user of the first terminal; and receiving feedback from the user of the first terminal, and storing the preference information about the target user group as a database or updating an existing database of target user group preference information with the preference information.

The user preference information may be stored in an ontology modeling-based triple form including information about resources, a property type, and a property value of a preferred item.

Searching for the route to the target user group may include searching for a route through which the target user group can be visited in the minimum time in consideration of context information related to speed of all accessible networks, a route through which the target user group can be visited at the minimum cost in consideration of context information related to usage fees of all the accessible networks, a route through which the target user group can be visited beginning with a user at the closest location in consideration of context information related to physical distance of target users, or a route on the basis of an existing usage habit of the user.

Obtaining preference information about each terminal may include obtaining preference information about each terminal using at least one of a method of skipping a visit using a timeout function when a specific user included in the route cannot be visited, a method of stopping a visit when sufficient information to compute the preference of the target user group is collected, and a method in which the maximum visit time for the target user group is set and a mobile agent collects information about the target user group within only the set time.

In other example embodiments, a context information sharing apparatus for providing an intelligent service by sharing context information between one or more terminals includes: a user context information manager configured to collect user behavior-based preference information including user log information about each terminal and sensor-based context information, identify a target user group by receiving a context information collection request for the target user group, collect multilateral context information through communication with at least one terminal included in the target user group, and compute preference of the target user group; a user preference information analyzer configured to compute user preference information by analyzing the user behavior-based preference information and sensor-based context information collected by the user context information manager; and a behavior recognition module configured to analyze the preference of the target user group computed by the user context information manager using user behavior modeling data, and provide the multilateral context information to a user.

The user context information manager may search for a route to the target user group, visit the at least one terminal included in the target user group to check whether the terminal has a collection user authority, obtain preference information about each terminal when the terminal has the collection user authority, and thereby collect the multilateral context information about the at least one terminal included in the target user group.

The behavior recognition module may gather preference information about the at least one terminal included in the target user group to compute and provide the preference information about the target user group to the user of the terminal, receive feedback from the user of the terminal, and store the preference information about the target user group as a database or update an existing database of target user group preference information with the preference information.

The context information sharing apparatus may further include a role-based access controller configured to set an access authority of at least one external user in connection with a role using at least one of profile information about the user, the context information about the target user group, and the preference information.

The role-based access controller may dynamically allocate or withdraw the role of the external user using at least one of a rule-based method, a machine learning-based method, and an inference-based method.

The context information sharing apparatus may further include: a user profile including information about a user of the corresponding terminal; a user preference information database configured to store the user preference information computed by analyzing the context information about a user; and a target user group database configured to store target user group data and the preference information.

The user context information manager may search for the route by searching for a route through which the target user group can be visited in the minimum time in consideration of context information related to speed of all accessible networks, a route through which the target user group can be visited at the minimum cost in consideration of context information related to usage fees of all the accessible networks, a route through which users can visit the target user group beginning with a user at the closest location in consideration of context information related to physical distance of target users, or a route on the basis of an existing usage habit of the user.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram of a multilateral context information sharing service according to an example embodiment of the present invention;

FIG. 2 is a block diagram of an apparatus for providing an intelligent service through multilateral context information sharing according to an example embodiment of the present invention; and

FIG. 3 is a flowchart illustrating a method of collecting multilateral user context information and recommending preference information about a target user group in a ubiquitous environment according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Conventional methods provide a service for collecting various pieces of context information about a user to infer complex context information and analyze the user's intention in a centralized fashion. On the other hand, example embodiments of the present invention provide a method of storing context information about a user in a ubiquitous terminal, constructing preference information about the user from the collected context information, collecting context information about a concerned target user group through communication between ubiquitous terminals, and presenting and recommending the most appropriate context information for preference of the target user group.

A method of collecting and recommending context information about a target user group to provide an intelligent service through multilateral context information sharing according to example embodiments of the present invention will be described below with reference to the appended drawings.

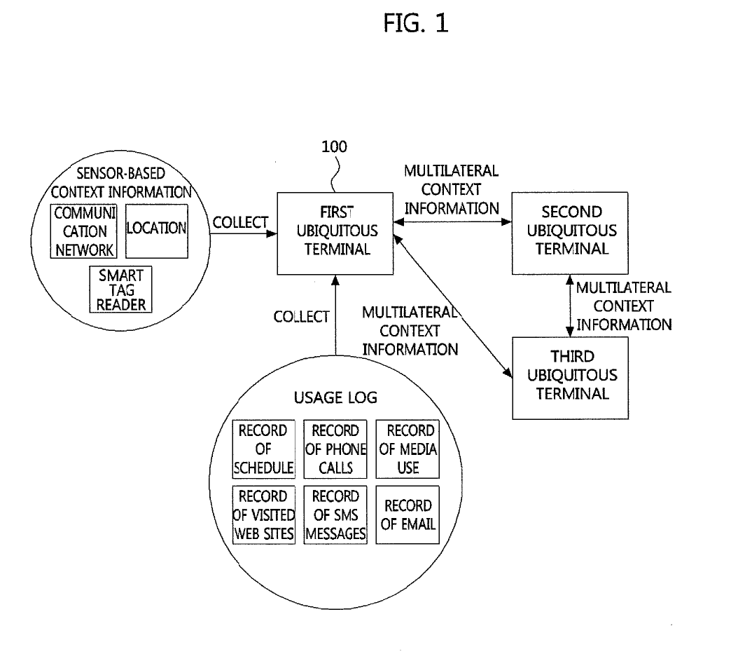

FIG. 1 is a conceptual diagram of a multilateral context information sharing service according to an example embodiment of the present invention.

A multilateral context information sharing service according to an example embodiment of the present invention stores context information about a user who utilizes the corresponding ubiquitous terminal, for example, a first ubiquitous terminal 100 in FIG. 1, in the ubiquitous terminal, constructs preference information about the user from the collected context information, collects context information about a concerned target user group through communication with other ubiquitous terminals (e.g., second and third ubiquitous terminals of FIG. 1), and presents and recommends the most appropriate context information for preference of the target user group.

To construct user preference information, the first ubiquitous terminal 100 collects a usage log about various usage forms, such as documents, photographs, music, moving pictures, web surfing, a short message service (SMS), and phone calls, in which a user utilizes the first ubiquitous terminal 100.

Also, to construct sensor-based context information, the first ubiquitous terminal 100 collects various pieces of sensible context information, such as spatial context, temporal context, environmental context, computing context, and resource context.

Further, a ubiquitous terminal (e.g., the first ubiquitous terminal 100 of FIG. 1) collects context information about a concerned target user group through communication with another ubiquitous terminal (e.g., the second or third ubiquitous terminal of FIG. 1).

More specifically, the first ubiquitous terminal 100 according to an example embodiment of the present invention analyzes preference information about a user from collected context information about the user, identifies a target user group when requested to collect context information about the target user group, searches for a route to the target user group, and visits a ubiquitous device of a target user to collect preference information. Also, the first ubiquitous terminal 100 computes preference information about the target user group to present and recommend the preference information, and updates the preference information about the target user group with user feedback.

The multilateral context information sharing service according to an example embodiment of the present invention has been described with reference to FIG. 1 focusing on the first ubiquitous terminal. However, the second and third ubiquitous terminals may also perform the same operation as the first ubiquitous terminal, and multilateral context information may be shared between ubiquitous terminals in an example embodiment of the present invention.

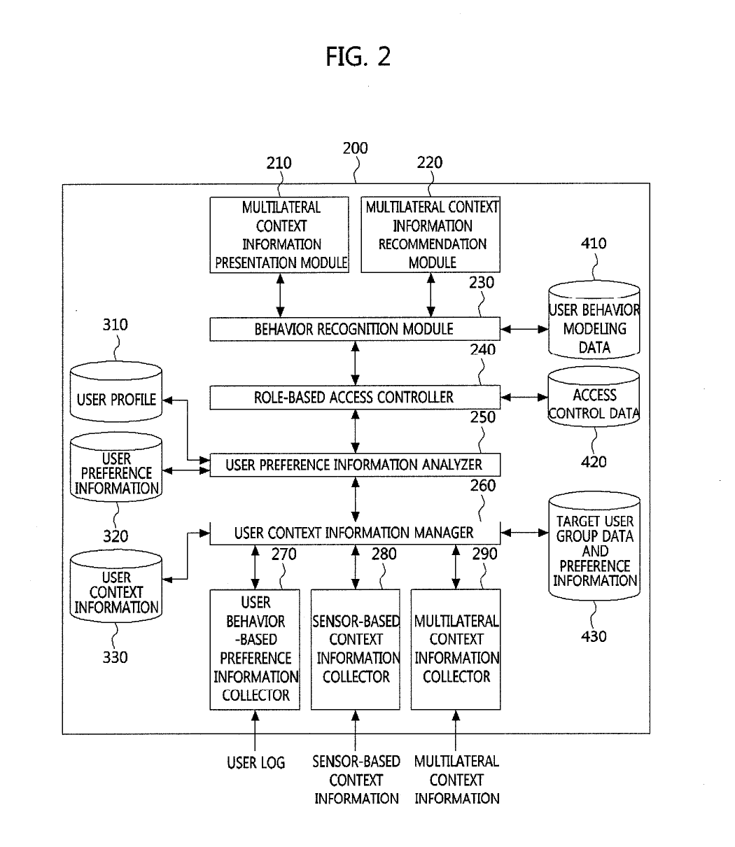

FIG. 2 is a block diagram of an apparatus for providing an intelligent service through multilateral context information sharing according to an example embodiment of the present invention.

A multilateral context information sharing apparatus 200 according to an example embodiment of the present invention is disposed in a ubiquitous terminal, and may include a multilateral context information presentation module 210, a multilateral context information recommendation module 220, a behavior recognition module 230, a role-based access controller 240, a user preference information analyzer 250, a user context information manager 260, a user behavior-based preference information collector 270, a sensor-based context information collector 280, and a multilateral context information collector 290.

The multilateral context information sharing apparatus 200 may also include databases such as a user profile database 310, a user preference information database 320, a user context information database 330, a user behavior modeling data database 410, an access control data database 420, and a target user group data and preference information database 430.

The multilateral context information sharing apparatus 200 according to an example embodiment of the present invention will be described in detail below with reference to FIG. 2.

The user behavior-based preference information collector 270 collects usage logs obtained from various forms, such as documents, photographs, music, moving pictures, web surfing, an SMS, and phone calls, in which users utilize a ubiquitous device. The sensor-based context information collector 280 collects various pieces of sensible sensor-based context information, such as spatial context, temporal context, environmental context, computing context, and resource context. The multilateral context information collector 290 visits ubiquitous devices of a target user group via wired/wireless networks, thereby collecting multilateral context information.

The user context information manager 260 stores information collected by the user behavior-based preference information collector 270 and the sensor-based context information collector 280 in the user context information database 330. The context information about the target user group collected by the multilateral context information collector 290 is stored in the target user group data and preference information database 430.

The user preference information analyzer 250 analyzes the collected context information about users, and computes and stores preference information about the users in the user preference information database 320. In an example embodiment of the present invention, preference information about users may be computed using a hybrid method in which one or more of a rule-based method, a machine learning-based method, and an inference-based method are combined. Also, in an example embodiment of the present invention, user preference information may be expressed in an ontology modeling-based triple form including information about resources, a property type, and a property value of a preferred item, and stored in the user preference information database 320 in this form.

Unlike conventional art, context information and preference information about users is not managed in a centralized fashion based on a client-server scheme, but rather encrypted and stored in ubiquitous devices of the users in an example embodiment of the present invention.

The user context information manager 260 computes and stores preference of the target user group in the target user group database 430. The target user group data stored in a ubiquitous device of a user is used to identify the target user group. Preference of a target user group, that is, a plurality of users having similar tendencies, may be computed using a similarity calculation method based on a user-item matrix.

The role-based access controller 240 performs a role-based access control function in which a user statically relates an authority for external users to a role and allocates a proper role to the external users. In other words, a role-based access control method according to an example embodiment of the present invention statically relates an authority for external users to a role on the basis of various pieces of context information, such as users' profile information, context information and preference information, and allocates a proper role to the external users. To control authority for an external user to collect information, the role-based access controller 240 may dynamically allocate or withdraw a role of the external user using a method in which one or more of a rule-based method, a machine learning-based method, and an inference-based method are combined.

The behavior recognition module 230 freely collects context information from the target user group in consideration of current context information using the user behavior modeling data database 410, analyzes preference information, and presents or recommends multilateral context information.

The multilateral context information presentation module 210 visualizes the multilateral context information transferred from the behavior recognition module 230, thereby presenting the multilateral context information to a user. The multilateral context information recommendation module 220 recommends target user group preference information transferred from the behavior recognition module 230 to the user, and updates the user preference information database 320 or the target user group preference information database 430 when there is clear feedback of the user.

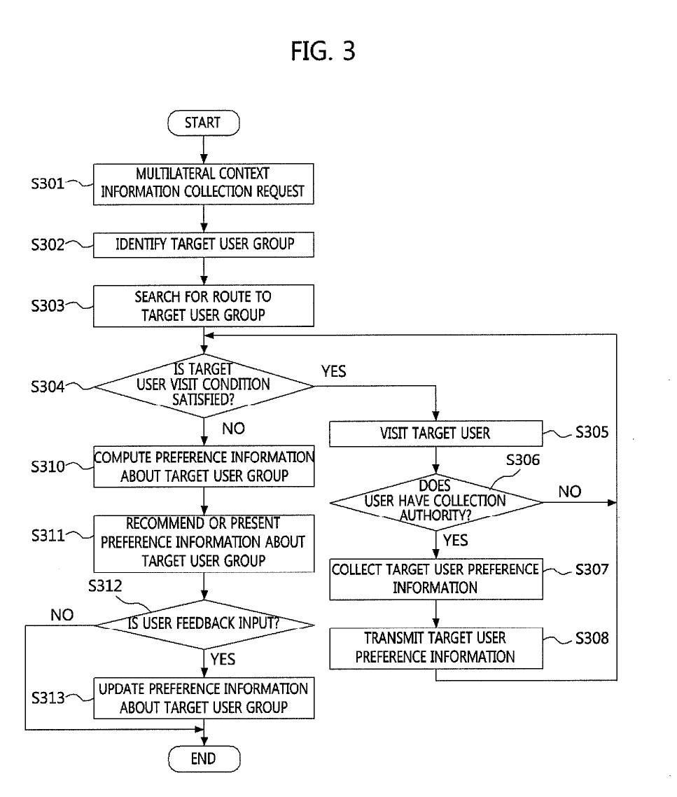

FIG. 3 is a flowchart illustrating a method of collecting multilateral user context information and recommending preference information about a target user group in a ubiquitous environment according to an example embodiment of the present invention.

First, when a multilateral context information collection request is generated by a clear request of a user or a behavior recognition module 230 (S301), a user context information manager 260 accesses respective identifications (IDs) of target users with reference to a target user group data and preference information database 430 to identify a target user group (S302), and searches for a route to ubiquitous devices of the target user group (S303).

Here, the route to the target user group may be found using various methods, such as a method of searching for a route through which the target user group can be visited in the minimum time in consideration of context information related to speed of all accessible networks, for example, a Bluetooth network, a near field communication (NFC) network, second generation/third generation (2G/3G) networks, a wireless Internet network, and a wired Internet network, a method of searching for a route through which the target user group can be visited at the minimum cost in consideration of context information related to usage fees of all the accessible networks, a method of searching for a route through which the target user group can be visited beginning with a user at the closest location in consideration of context information related to physical distance of the target users, or a method of searching for a route on the basis of an existing usage habit of a user.

Searched information about a route to the target user group is transferred to a multilateral context information collector 290, and the multilateral context information collector 290 determines whether a target user visit condition is satisfied (S304). When the target user visit condition is satisfied, a device of a target user is visited (S305).

Here, a multilateral context information sharing engine of the target user checks authority of a visiting user through a role-based access controller 240 (S306), and then provides a user preference information only when the visiting user has authority. The multilateral context information collector 290 transmits collected target user preference information in consideration of minimum time context information when a visit to each device or all devices is finished.

A ubiquitous terminal of a target user may be visited using various methods, such as a method of skipping a visit using a timeout function when a specific user included in the route cannot be visited, a method of stopping a visit to prevent unnecessary search when sufficient information to compute preference of the target user group is collected, a method in which the maximum visit time for the target user group is set and a mobile agent collects information about the target user group within only the set time, and a method of transmitting information collected by visiting each target user every time without gathering context information about the target user group.

When it is determined in step 304 that the target user visit condition is not satisfied, the multilateral context information collector 290 finishes route search, and the user context information manager 260 computes collected preference information about the target user group (S310) and presents or recommends the preference information about the target user group according to context (S311). Here, the preference of the target user group having a similar tendency may be computed using a similarity calculation method based on a user-item matrix.

In response to the information presented or recommended by the multilateral context information sharing engine, a user inputs feedback such as acceptance, refusal, and modification (S312). When feedback of a user is input, the feedback is reflected in a target user group database by a multilateral context information presentation module 210 or a multilateral context information recommendation module 220, and target user group preference information is updated with the feedback (S313). Although not illustrated in FIG. 3, a multilateral context information sharing apparatus 200 may continuously update preference information without clear feedback of a user in an example embodiment of the present invention.

As described above, using a context information presentation and recommendation engine executed in a distributed computing method by a ubiquitous device, example embodiments of the present invention can provide an intelligent service for analyzing preference information that is meaningful to a user from various pieces of collected context information about the user, collecting context information about a concerned target user group through communication between ubiquitous terminals, and presenting and recommending appropriate context information for preference of the target user group.

Also, example embodiments of the present invention can solve the problems of misuse of personal information, extensibility, autonomy, etc. resulting from a conventional client-server scheme in which profiles of users and context information are managed in a centralized fashion.

While the example embodiments of the present invention and their advantages have been described in detail, it should be understood that various changes, substitutions and alterations may be made herein without departing from the scope of the invention.

What is claimed is:

1. A context information sharing method for providing an intelligent service by sharing context information between one or more terminals, comprising:
collecting, at the one or more terminals, user behavior-based preference information including user log information about each terminal and sensor-based context information;
storing, at the one or more terminals, the collected preference information and context information in each terminal as a database;
receiving, at a first terminal among the one or more terminals, a context information collection request for a target user group and identifying the target user group;
collecting, at the first terminal, context information about at least one terminal included in the identified target user group; and
providing, at the first terminal, preference information about the target user group extracted on the basis of the collected context information about the target user group to a user.

2. The context information sharing method of claim 1, wherein the one or more terminals are ubiquitous terminals.

3. The context information sharing method of claim 1, wherein collecting, at the first terminal, the context information about the at least one terminal included in the identified target user group includes:
searching for a route to the target user group;
visiting the at least one terminal included in the target user group to check whether the first terminal has a collection user authority; and
obtaining preference information about each terminal when the first terminal has the collection user authority.

4. The context information sharing method of claim 1, wherein providing, at the first terminal, the preference information about the target user group extracted on the basis of the collected context information about the target user group to the user includes:
gathering preference information about the at least one terminal included in the target user group to compute the preference information about the target user group;
providing the preference information about the target user group to the user of the first terminal; and
receiving feedback from the user of the first terminal, and storing the preference information about the target user group as a database or updating an existing database of target user group preference information with the preference information.

5. The context information sharing method of claim 1, wherein the user preference information is stored in an ontology modeling-based triple form including information about resources, a property type, and a property value of a preferred item.

6. The context information sharing method of claim 3, wherein searching for the route to the target user group includes searching for a route through which the target user group can be visited in the minimum time in consideration of context information related to speed of all accessible networks, a route through which the target user group can be visited at the minimum cost in consideration of context information related to usage fees of all the accessible networks, a route through which the target user group can be visited beginning with a user at the closest location in consideration of context information related to physical distance of target users, or a route on the basis of an existing usage habit of the user.

7. The context information sharing method of claim 3, wherein obtaining preference information about each terminal includes obtaining preference information about each terminal using at least one of a method of skipping a visit using a timeout function when a specific user included in the route cannot be visited, a method of stopping a visit when sufficient information to compute the preference of the target user group is collected, and a method in which the maximum visit time for the target user group is set and a mobile agent collects information about the target user group within only set the time.

8. A context information sharing apparatus for providing an intelligent service by sharing context information between one or more terminals, comprising:
a user context information manager configured to collect user behavior-based preference information including user log information about each terminal and sensor-based context information, identify a target user group by receiving a context information collection request for the target user group, collect multilateral context information through communication with at least one terminal included in the target user group, and compute preference of the target user group;
a user preference information analyzer configured to compute user preference information by analyzing the user behavior-based preference information and the sensor-based context information collected by the user context information manager; and
a behavior recognition module configured to analyze the preference of the target user group computed by the user context information manager using user behavior modeling data, and provide the multilateral context information to a user.

9. The context information sharing apparatus of claim 8, wherein the one or more terminals are ubiquitous terminals.

10. The context information sharing apparatus of claim 8, wherein the user context information manager searches for a route to the target user group, visits the at least one terminal included in the target user group to check whether the terminal has a collection user authority, obtains preference information about each terminal included in the target user group when the terminal has the collection user authority, and thereby collects the multilateral context information about the at least one terminal included in the target user group.

11. The context information sharing apparatus of claim 8, wherein the behavior recognition module gathers preference information about the at least one terminal included in the target user group, computes the preference information about the target user group to recommend or provide the multilateral context information to the user of the terminal, receives feedback from the user of the terminal, and stores the preference information about the target user group as a database or updates an existing database of target user group preference information with the preference information.

12. The context information sharing apparatus of claim 8, further comprising a role-based access controller configured to set an access authority of at least one external user in connection with a role using at least one of profile information about the user, the context information about the target user group, and the preference information.

13. The context information sharing apparatus of claim 12, wherein the role-based access controller dynamically allocates or withdraws the role of the external user using at least one of a rule-based method, a machine learning-based method, and an inference-based method.

14. The context information sharing apparatus of claim 8, further comprising:
a user profile including information about a user of a corresponding terminal;
a user preference information database configured to store the user preference information computed by analyzing the context information about a user; and
a target user group database configured to store target user group data and the preference information.

15. The context information sharing apparatus of claim 10, wherein the user context information manager searches for the route by searching for a route through which the target user group can be visited in the minimum time in consideration of context information related to speed of all accessible networks, a route through which the target user group can be visited at the minimum cost in consideration of context information related to usage fees of all the accessible networks, a route through which users can visit the target user group beginning with a user at the closest location in consideration of context information related to physical distance of target users, or a route on the basis of an existing usage habit of the user.
